(19) United States
(12) Patent Application Publication
(10) Pub. No.: US 2013/0162380 A1
(43) Pub. Date: Jun. 27, 2013

(54) CONNECTION DEVICE WITHOUT ELECTRICAL CONTACT, ALLOWING THE TRANSMISSION OF THREE-PHASE ELECTRICAL POWER

(71) Applicants: Stephane Tollet, Marseille (FR); Gabriel Grenon, Marseille (FR); Alain Fidani, Marseille (FR); Gilles Lacour, Belly (FR)

(72) Inventors: Stephane Tollet, Marseille (FR); Gabriel Grenon, Marseille (FR); Alain Fidani, Marseille (FR); Gilles Lacour, Belly (FR)

(73) Assignee: CYBERNETIX, Marseille Cedex 13 (FR)

(21) Appl. No.: 13/807,162

(22) PCT Filed: Jun. 29, 2011
(86) PCT No.: PCT/FR11/51525

§ 371 Date: Mar. 1, 2013

(30) Foreign Application Priority Data
Jun. 30, 2010 (FR) 10 02754

(51) Int. Cl. H01F 38/14

(52) U.S. Cl. CPC H01F 38/14
USPC 336/55; 336/119

(57) ABSTRACT

The invention relates to a connection device, without electrical contact, between a source and a load in order to transmit AC electrical power having a frequency below 2 kHz and at least one phase, the device comprising two parts being able to be separated and assembled at will in a particular configuration suitable for transferring power without electrical contact, a primary part (P1) intended to be connected to the source, and a secondary part (P2) intended to be connected to the load. The invention is such that, once assembled, the two parts form a structure similar to the structure of an asynchronous or synchronous three-phase stator/rotor motor.

### BACKGROUND OF THE INVENTION

The present invention relates to the general field of connection devices between a source and a load in order to transmit AC electrical power having at least one phase.

The invention more particularly relates to connection devices without an electrical contact.

These connection devices are more particularly dedicated to use in a conductive setting, typically in marine or aquatic environments, where connections with an electrical contact are generally unsuitable and not very reliable.

It is currently known to perform a power transfer without electrical contact using an inductive phenomenon and a high frequency signal.

FIG. 1 describes such an electrical power transfer device according to the prior art for a direct current DC or an alternating current AC.

When the current is a direct current DC, it is sent directly toward a transfer function T1, where the direct current DC is converted into an inductive high-frequency signal HF.

When the current is an alternating current AC, irrespective of whether it is a three-phase current, FIG. 1 shows in dotted lines that that current AC is supplied to the input of an AC/DC converter C1 so as to be converted into direct current DC. This direct current DC is then sent toward the transfer function F1.

In the known devices, the coils of the primary and secondary circuits are face to face during the electrical power transfer. This characteristic is diagrammed in FIG. 1 by the coil of the primary circuit B₁ across from the coil of the secondary circuit B₂. Inasmuch as this is a device without electrical contact, the coils B1 and B2 are necessarily separated by an air gap. Nevertheless, when a current circulates in a coil B₁, the created magnetic field creates a high-frequency induced current in the coil B₂ facing it.

This induced high-frequency current HF is then processed within a transfer function T2 that converts the high-frequency signal HF into a direct component DC.

As needed, this direct component DC is then optionally transmitted to a DC/AC converter C2 shown in dotted lines and making it possible to restore an alternating current AC on one or three phases as needed.

In this way, the magnetic field created by the circulation of the high-frequency signal in the coil of the primary circuit generates, within the coil of the secondary circuit, an induced current circulation that makes it possible to supply the electrical power.

Such a power transfer requires the use of a high-frequency signal and the presence of electronics dedicated to converting the available signal into one such high-frequency signal.

In this way, low-frequency electrical powers, or within the meaning of the invention, signals with a frequency below 2 kHz, will not be likely to be transmitted from one part of the connection device to the other part in the absence of electronics dedicated to converting the signal.

This is a particular handicap in hostile settings, of the underwater type, since it is well known that electronic components are very sensitive to hostile atmospheres and are subject to breakdowns. The use of such electronics in these settings would create low robustness, a short lifetime, and poor reliability of the connection device. Furthermore, in the case of a breakdown, the high costs and operating difficulties are prohibitive. It will be noted here that the implementation of electronic components is also not desirable in other types of hostile environments such as sandy deserts, settings where the elements are soaked in oil, etc. The invention can thus be implemented in various fields. In fact, the invention makes it possible to do away with the need to perform careful cleaning of the connectors, or the need to insulate the connectors from the medium in which they are working.

In all of these hostile environments, it is particularly crucial to allow a transfer of power in the absence of specific electronics near the connection device.

### SUBJECT-MATTER AND BRIEF DESCRIPTION OF THE INVENTION

The primary aim of the present invention is therefore to offset the drawbacks of the prior art and to make it possible to transfer three-phase electrical power without having to modify the frequency of the transmitted signal by proposing a connection device, without electrical contact, between a source and a load in order to transmit AC electrical power having a frequency below 2 kHz and having at least one phase, the device comprising a primary part intended to be connected to the source and a secondary part intended to be connected to the load, said two parts being able to be separated and assembled at will in a particular configuration suitable for transferring power without electrical contact; each of the parts comprising an element made from a ferromagnetic material and at least one coil that are both encased in a sealed enclosure,

the forms of the two ferromagnetic elements being such that once the two parts are assembled, the two ferromagnetic elements form a closed ferromagnetic circuit having, after assembly, a plurality of minor discontinuities at the sealed enclosures encasing the parts,

and the respective positions of the coils relative to the respective ferromagnetic elements being such that once the two parts are assembled, the coil of the primary part, called the primary coil, surrounds one branch of the ferromagnetic circuit, which is then capable of conducting a magnetic flow created by an alternating current circulating in said so-called primary coil and the coil of the secondary part, called the secondary coil, also surrounds one branch of the ferromagnetic circuit, an induced current therefore circulating in the secondary coil once the magnetic circuit is passed through by a variable magnetic flow,

the device being characterized in that, the electrical power being three-phase, one of the so-called male parts has a shape allowing it to coaxially penetrate, when the parts are assembled, a complementary orifice borne by the other, so-called female part, the ferromagnetic elements of the male part and the female part both having asymmetry of revolution, are provided on the outer surface and on the inner surface respectively, with a same number 6N of longitudinal columns regularly distributed over the section of the ferromagnetic elements and forming as many branches of the ferromagnetic circuit, N being the number of pairs of poles per phase, N being greater than or equal to 1, these columns allowing the winding of 3N coils, the windings of the 3N coils being done so as, on the male part and on the female part, respectively, to form a structure similar to the structure of a three-phase asynchronous or synchronous stator/rotor motor.

With the invention, the two parts are provided with complementary ferromagnetic elements such that a closed magnetic circuit is recreated during the assembly of the two parts with the exception of minor discontinuities situated at the air gap. It is already known that the presence of ferromagnetic materials makes it possible to facilitate the circulation or conduction of the magnetic field. Thus, below 2 kHz, it is possible to transmit power without electronics and therefore to make the system robust and reliable, the materials used being specifically chosen for their magnetic characteristics. Furthermore, the device according to the invention is such that the reconstituted magnetic circuit is closed, it is the seat of a favored conduction of the magnetic field that allows the transfer of the low-frequency electrical power from the primary part to the secondary part.

The encasing in a sealed enclosure may be done by coating with a sealing material, typically resin, by encapsulating within an enclosure, a housing, or a sealed case potentially including dielectric oil submerging the ferromagnetic element and the coils and making it possible to balance the pressure with the outside of the sealed enclosure, or by any other means making it possible to keep the ferromagnetic element insulated from the outside environment.

The shapes of the parts also allow assembly in the particular configuration. These forms therefore constitute guide means for guiding the parts relative to each other.

The invention makes it possible to obtain a connection device having a symmetry of revolution that greatly facilitates the assembly of the two parts. The complementary shapes of symmetry of revolution of the male and female parts are typically cylindrical or conical shapes, the most important aspects being that the male part can penetrate the female part and that each of the parts can bear the coils useful for implementing that embodiment. Furthermore, this embodiment makes it possible to implement several poles per phase easily on the contours of the male and female parts. The electrical power is then recovered directly on the poles of the secondary part in the form of three-phase current reconstituted from the induced currents. The coils of the secondary part are to that end specifically connected to three output wires of the secondary part.

According to one advantageous feature, the center of the male part is hollowed out so as to facilitate heat exchanges by convection.

This feature makes it possible to ensure good thermal regulation of the connection device.

According to one particular feature, the male and female parts comprise at least two complementary mistake-proofing elements on the outer and inner contours, respectively, of the male and female parts so as to allow assembly of the male part in the female part in a particular position where each column of the male part faces a column of the female part.

The mistake-proofing elements, typically a lug complementary to a notch, allow accurate positioning of the two parts relative to one another.

It will be noted here that the number of mistake-proofing elements may be multiplied over at least one of the parts, said mistake-proofing elements being regularly distributed on the outer and inner contours, respectively, of the ferromagnetic elements of the male and female parts so as to allow the male part to penetrate the female part only for the positions where each column of the male part faces a column of the female part. Typically, one of the parts may have a lug and the other part may have as many notches as there are columns. In this way, the lug may be positioned indifferently in one or the other of the notches, nevertheless ensuring correct relative positioning of the columns of the primary circuit across from the columns of the secondary circuit.

However, when the created field is rotary, aligning the columns is not useful to obtain a correct and constant output. Except under particular circumstances, it will therefore be advantageous not to implement mistake-proofing elements so as to be able to assemble the two parts in any relative angular positions. This any assembly makes it possible to access significant simplicity of assembly of the two parts.

However, it will be noted that these mistake-proofing elements are not useful to immobilize the two parts of the connector when the object on which the two parts of the connector are placed are in stationary positions during operational periods. This is the case on underwater equipment where the connectors are placed stationary relative to said pieces of equipment, which are in a predetermined position relative to each other during power transfer operations.

The number of pairs of poles per phase will advantageously be two or three.

According to one preferred feature of the invention, the enclosures of the parts and the parts have dimensions such that the minor discontinuities at the air gap are comprised between 2 and 40 mm.

The distance of 2 mm corresponds to a fine thickness of sealing material on the surfaces of the ferromagnetic elements designed to be brought closer together during assembly of the parts. The play between the two parts is then very reduced. The distance of 40 mm increases the phase shift UI introduced by the crossing of the discontinuity. Beyond that distance, the transfer of power is no longer correct for the frequencies concerned by the invention.

In one advantageous embodiment, the discontinuities are situated between 4 and 20 mm. This interval allows the presence of correct play while ensuring a good transfer of power.

In one preferred embodiment, the discontinuities are situated between 5 and 10 mm. In this interval, a very good transfer of power is ensured as well as the presence of play allowing suitable guiding of the parts relative to each other.

It will be noted here that the cylindrical geometry of the parts makes it possible to ensure the presence of play, unlike the use of two conical parts, one of which would rest on the other.

This feature makes it possible to ensure that the discontinuities are minor relative to the overall size of the magnetic circuit.

In one favored application, the device according to the invention is designed to be implemented, for one of the two parts on an underwater base, and for the other part on a vehicle, a sensor or an underwater actuator designed to be placed on the underwater base to ensure a transfer of electrical power between the two parts.

The possibility of being able to connect two parts easily to perform a transfer of power without electrical contact and without electronics is expected in the field of underwater exploitation. The transfer of power may be done from the vehicle toward the base or vice versa as a function of the needs of the application. The subject-matter of the invention, which causes the two parts to have a certain mass, is also not a handicap in underwater applications, which makes it a favored field of exploitation for the invention.

According to one advantageous feature, each part of the device can be fixedly attached on the underwater base and on the vehicle.

With this feature, the positioning of the vehicle on the base suffices to connect the two parts and immobilize the two parts relative to each other. In fact, a vehicle parked on an underwater base may not pivot relative to that base and is positioned in a predetermined manner relative thereto.

### BRIEF DESCRIPTION OF THE DRAWINGS

Other features and advantages of the present invention will emerge from the following description, done in reference to the appended drawings, which illustrate one example embodiment that is in no way limiting. In the figures:

FIG. 1 shows the principle of a device for transmitting power by induction according to the prior art;

FIG. 2 shows the principle of a device for transmitting power by induction according to the invention in mono-phase;

FIG. 3 diagrammatically shows one embodiment of the invention for a three-phase current shown without coils;

FIG. 4 shows the ferromagnetic elements of the embodiment with two illustrated coils;

FIG. 5 shows the magnetic flow lines in the ferromagnetic elements of the embodiment of the device according to the invention, over a section of the ferromagnetic elements.

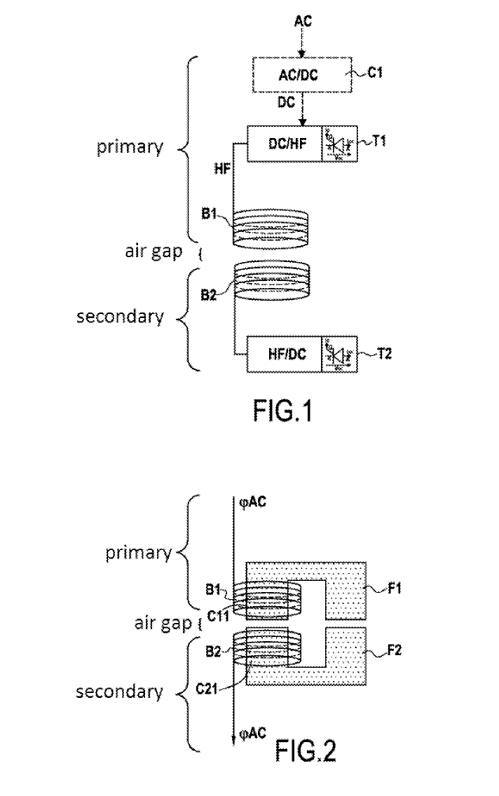

### DETAILED DESCRIPTION OF THE INVENTION

FIG. 2 diagrammatically describes the principle according to the invention, which avoids the presence of a certain number of pieces of electronic equipment to perform the current and frequency conversions. In this figure, the transmission of a mono-phase alternating electrical power φAC with a frequency lower than 2 kHz is described. The current is brought directly to a coil B1 without modifying the frequency. The coil B1 is wound around a column C11 of the ferromagnetic element F1, said column forming a branch of the ferromagnetic circuit. The ferromagnetic element F1 is generally C-shaped. Across from said ferromagnetic element F1, a ferromagnetic element F2 is placed that is identical to the element F1 and around which a coil B2 is wound. Typically, the ferromagnetic elements are made up of sheet metal pieces that are cut out, then pressed against each other. The assembly of the pieces of sheet metal thus brought together then forms the ferromagnetic element. This manufacturing technique is known for manufacturing transformers in which the magnetic circuit is built to be closed without an air gap and with no possibility of disconnection/assembly. The primary and secondary circuits each comprise a coil B1 for the primary circuit and B2 for the secondary circuit, respectively, and a ferromagnetic element F1 for the primary circuit and F2 for the secondary circuit.

The ferromagnetic elements are such that the coils B1 and B2 are respectively wound around a column C11 and C21 of the corresponding ferromagnetic element.

The two ferromagnetic elements F1 and F2 are separated only by a minor discontinuity. In that position, they then form a closed magnetic circuit along which the magnetic flow circulates that is created by the presence of a magnetic field created within the coil B1 when a current circulates therein. The field induces currents within the coil B2. These are induced currents that allow the transfer of electrical power.

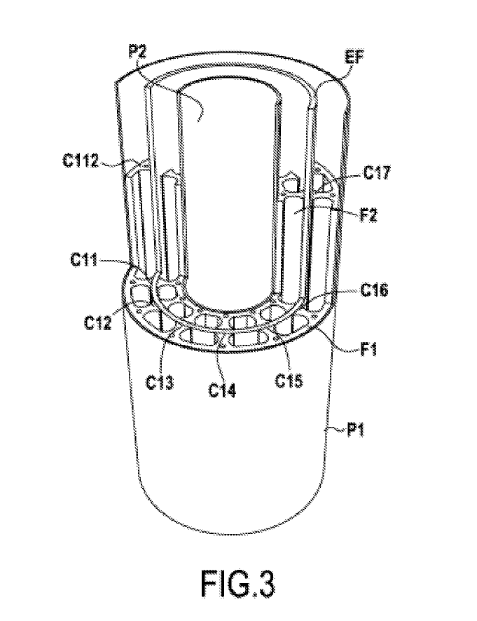

FIG. 3 shows an embodiment in which the two ferromagnetic elements and their coils have a structure with similarities relative to the structure of a three-phase asynchronous or synchronous stator/rotor motor. It will, however, be noted here that the poles of each phase of the male part are not short-circuited, but specifically connected to the output wires of the part of the connector so as to be connected to the source or the load as a function of the primary or secondary role of the part within the connector.

A female part, which is designated as the primary part P1 in the example of FIG. 3, to that end comprises a generally cylindrical ferromagnetic element F1 on the inner surface of which radial columns are formed, here 12 columns C12 to C112, which are longitudinal and follow the axis of the cylinder. In the case at hand, the columns on which the winding of the coils bears are defined by an equal number of notches E1i (E2i, respectively) and columns C1i (C2i, respectively) in the contour of the part P1 (P2, respectively). It will be noted that advantageously, the notches are such that the columns have a T-shaped structure on the section perpendicular to the axis of the male and female parts. This T-shaped structure has the dual advantage of keeping the windings at the bottom of the notch and decreasing leakage lines.

These radial columns C11 to C112 here allow the winding of six coils in the manner used to manufacture three-phase asynchronous motors with two pairs of poles.

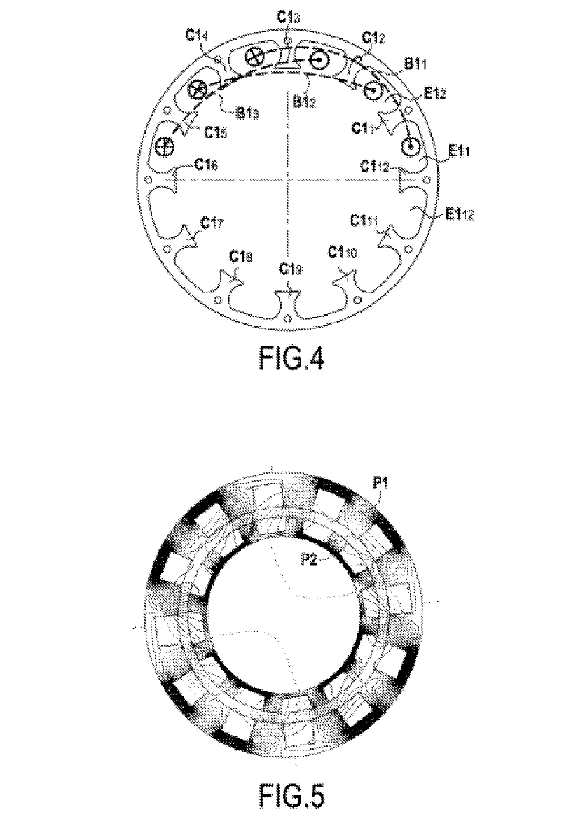

Generally, the coils are assembled in the notches so as to produce one or more pairs of poles per phase. The winding of the coils on the primary part P1 is diagrammatically illustrated in FIG. 4, which shows the paths, shown in dashes, of three coils B11, B12 and B13 each wound around a first column C1i and another column C1i+2. The coils B11, B12, B13 of the three phases are in fact wound while overlapping. The looping of a first coil passing between the columns C1i−1 and C1i is then made three columns further between the columns C1i+2 and C1i+3. This amounts to looping each coil by using the notches Ei and Ei+3. Once 2+2+2=6 successive notches are used to wind three coils, half of the notches, all situated on the same side of the part, are filled. The winding process is then started again with three new coils that each represent the second hole for each of the phases that wind on the six remaining notches on the other side of the part in a manner similar to that described above.

The male part, which here is designated as the secondary part P2, is also generally cylindrical, potentially hollow to improve heat exchanges with the outside environment. Its outer surface is provided with the same number of longitudinal radial columns, which follow the axis of the cylinder, like the primary part P1. Six coils are also wound thereon in the manner diagrammatically shown in FIG. 4.

The two ferromagnetic elements F1 and F2 are separated by an air gap denoted EF and diagrammatically shown in the form of a cylinder. In that cylinder EF, the thicknesses of the sealed materials are shown surrounding the two parts, not shown in FIG. 3, and the play that is essential for the assembly.

The two parts may include one or more mistake-proofing elements making it possible to align the columns across from each other. Typically, a lug protruding from the secondary part P2 will be designed to be engaged in a notch formed in the part P1. It will be noted here that a single notch may be present, ensuring that the positioning is always exactly the same. However, it will be noted here that a number smaller than or equal to 12 notches may also be formed on a part P1, said notches ensuring a plurality of possible positions where, however, the columns of the two parts P1 and P2 will be aligned.

Nevertheless, since the field obtained with the three phases is a rotating magnetic field, the aligned positioning of the parts is not essential. It is also generally advantageous for the assembly of the two parts to be able to be done in any angular position.

Nevertheless, a slight offset between the columns not hindering the overall performance of the transmission power, this is not useful in most cases solely to perform the energy transfer.

It will also be noted here, in the case of the use of a connector according to the invention in a context where each of the male and female parts is fixedly attached to the two objects to be connected, the use of such a mistake-proofing device is purposeless. In fact, when the connector is installed on an autonomous vehicle or a moving underwater system on the one hand, and an underwater base on the other hand, the uniqueness of the positioning of the vehicle or moving system on the base makes the use of a mistake-proofing element superfluous. Furthermore, this unique positioning is generally ensured by elements making it possible to lock the moving vehicle or system in position. The rotation of the part fixedly attached to the moving vehicle or system relative to the base on which the other part is fixedly attached is then prevented. The structure, which is however comparable to that of a stator/rotor motor, then cannot trigger a relative movement of one of the parts with respect to the other.

In the embodiment of FIGS. 3 and 4, the connection device is such that each phase is associated with two pairs of poles. This implies the presence of six coils distributed over the contour of the ferromagnetic elements F1 and F2.

When a three-phase alternating current circulates in the pairs of poles each associated with a phase, it will be noted that the continuously modified magnetic flow follows the field lines passing through the minor discontinuities at the air gap between the parts P1 and P2. It is then the variations of the magnetic flow that create the currents induced within the coils of the secondary part P2. Measurements done on a prototype described by FIG. 5 have shown that, even when the columns of the part P2 are perfectly aligned with the gaps of the part P1, the transmitted power varies little due to the rotating field.

FIG. 5 shows the distributions of the magnetic flows at a given moment for a connection device according to the second embodiment. One can see that the magnetic flow passes through the air gap at the various discontinuities of the magnetic circuit formed by the two ferromagnetic elements F1 and F2. The closure of the magnetic circuit obtained owing to the particular form of the ferromagnetic elements with which each of the parts is provided makes it possible to establish the magnetic field for low frequencies of the signal below 2 kHz.

Lastly, it should be noted that various embodiments may be done according to the principles of the invention.

1. A connection device, without electrical contact, between a source and a load in order to transmit AC electrical power having a frequency below 2 kHz and having at least one phase, the device comprising a primary part (P1) intended to be connected to the source and a secondary part (P2) intended to be connected to the load,
said two parts being able to be separated and assembled at will in a particular configuration suitable for transferring power without electrical contact
each of the parts (P1, P2) comprising an element made from a ferromagnetic material (F1, F2) and at least one coil (B1, B2) that are both encased in a sealed enclosure (M),
the forms of the two ferromagnetic elements (F1, F2) being such that once the two parts (P1, P2) are assembled, the two ferromagnetic elements (F1, F2) form a closed ferromagnetic circuit having, after assembly, a plurality of minor discontinuities at the sealed enclosures (M) encasing the parts,
and the respective positions of the coils (B1, B2) relative to the respective ferromagnetic elements (F1, F2) being such that once the two parts (B1, P2) are assembled, the coil of the primary part (P1), called the primary coil (B1), surrounds one branch of the ferromagnetic circuit, which is then capable of conducting a magnetic flow created by an alternating current circulating in said so-called primary coil (B1) and the coil of the secondary part (P2), called the secondary coil (B2), also surrounds one branch of the ferromagnetic circuit, an induced current therefore circulating in the secondary coil (B2) once the magnetic circuit is passed through by a variable magnetic flow,
the device being characterized in that, the electrical power being three-phase, one of the so-called male parts (P2) has a shape allowing it to coaxially penetrate, when the parts (P1, P2) are assembled, a complementary orifice borne by the other, so-called female part (P1), the ferromagnetic elements (F1, F2) of the male part (P2) and the female part (P1) both having a symmetry of revolution, are provided on the outer surface and on the inner surface respectively, with a same number 6N of longitudinal columns (C1i, C2i) regularly distributed over the section of the ferromagnetic elements (F1, F2) and forming as many branches of the ferromagnetic circuit, N being the number of pairs of poles per phase, N being greater than or equal to 1, these columns (C1i, C2i) allowing the winding of 3N coils, the windings of the 3N coils being done so as, on the male part (P2) and on the female part (P1), respectively, to form a structure similar to the structure of a three-phase asynchronous or synchronous stator/rotor motor.

2. The device according to claim 1, characterized in that the center of the male part (P2) is hollowed out so as to facilitate heat exchanges by convection.

3. The device according to claim 1, wherein the enclosures (M) of the parts and the parts (P1, P2) have dimensions such that the minor discontinuities at the air gap are comprised between 2 and 40 mm.

4. The device according to claim 1, characterized in that the enclosures (M) of the parts and the parts (P1, P2) have dimensions such that the minor discontinuities at the air gap are comprised between 4 and 20 mm.

5. The device according to claim 4, characterized in that the enclosures (M) of the parts and the parts (P1, P2) have dimensions such that the minor discontinuities at the air gap are comprised between 5 and 10 mm.

6. The device according to claim 1, designed to be implemented, for one of the two parts on an underwater base, and for the other part on a moving system, vehicle, a sensor or an underwater actuator designed to be placed on the underwater base to ensure a transfer of electrical power between the two parts.

7. The device according to claim 6, characterized in that each part of the device can be fixedly attached on the underwater base and on the vehicle.
